(19) United States
(12) Patent Application Publication
(10) Pub. No.: US 2010/0028675 A1
(43) Pub. Date: Feb. 4, 2010

(54) PROCESS OF PURIFYING NANODIAMOND COMPOSITIONS AND APPLICATIONS THEREOF

(76) Inventors: Yury Gogotsi, Warminster, PA (US); Vadym Mochalin, Philadelphia, PA (US); Sebastian Osswald, Philadelphia, PA (US); Gleb Yushin, Atlanta, GA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/300,660

(22) PCT Filed: May 14, 2007
(86) PCT No.: PCT/US07/11607

§ 371 Date: Apr. 16, 2009

Related U.S. Application Data
(60) Provisional application No. 60/800,627, filed on May 15, 2006.

(51) Int. Cl. C01B 31/06

(52) U.S. Cl. 428/402; 423/446; 977/773

(57) ABSTRACT

The presence of large amounts of non-diamond carbon in detonation synthesized nanodiamond (ND) severely limits applications of this exciting nanomaterial. An environmentally-friendly process is disclosed to selectively remove sp²-bonded carbon from ND. The content of up to 96% of sp³-bonded carbon in the oxidized samples is comparable to that found in microcrystalline diamond and is unprecedented for ND powders. Transmission electron microscopy and Fourier transform infrared spectroscopy studies show high purity 5-nm ND particles covered by oxygen-containing surface functional groups. The surface functionalization can be controlled by subsequent treatments. In contrast to current purification techniques, the disclosed process does not require the use of toxic or aggressive chemicals, catalysts or inhibitors and opens avenues for numerous new applications of nanodiamond.

### CROSS REFERENCE TO RELATED APPLICATIONS

The present application claims priority to U.S. Provisional Patent Application No. 60/800,627, entitled “PROCESS OF PURIFYING NANODIAMOND COMPOSITIONS AND APPLICATIONS THEREOF,” filed May 15, 2006, which is hereby incorporated by reference in its entirety.

### FIELD OF THE INVENTION

The disclosed invention pertains to the field of nanodiamonds. The disclosed invention also pertains the field of carbon chemistry. The disclosed invention also pertains to the field of chemical purification.

### BACKGROUND OF THE INVENTION

Ultrananocrystalline diamond (“nanodiamond”) is a unique nanomaterial which can be easily produced in hundred of kilograms by detonation synthesis. Unfortunately there are no detonation synthesis techniques known at the present time which would give pure nanodiamond product ready for commercial applications. Diamond-bearing soot is obtained as a result of detonation synthesis which consists of nanodiamond particles (for example, having an average diameter of about 5 nm) contaminated by different kinds of non-diamond carbon as well as metals and metal oxides particles coming from the material of the detonation chamber. Accordingly, purification of the nanodiamond detonation product is needed. The purification stage is considered to be the most complicated and expensive stage in producing nanodiamonds.

The raw diamond-bearing soot obtained during detonation synthesis includes nanodiamond particles, non-diamond carbon, as well as metals, metal oxides and other impurities coming from the detonation chamber or the explosives used. The purification treatment is the most complicated and expensive stage of the ND production (Dolmatov, V. Y., Detonation synthesis ultradispersed diamonds: properties and applications. Russian Chemical Reviews 2001, 70, (7), 607-626). Most producers employ wet chemistry approaches to purify ND (Gruen, D. M.; Shenderova, O. A.; Vul, A. Y., Synthesis, Properties and Applications of Ultrananocrystalline Diamond. Springer: Dordrecht, 2005). While these techniques are widely used, they do not provide sufficient purity of ND leading to the black or dark-grey color of commercially available ND powders. In addition, liquid phase purification is not an environmentally friendly process and requires expensive corrosion-resistant equipment and costly waste disposal processes. Alternative dry chemistry approaches, including catalyst assisted oxidation (Gubarevich, T. M.; Sataev, R. R.; Dolmatov, V. Y. In Chemical purification of ultradisperse diamonds, 5th All-Union Meeting on Detonation, Krasnoyarsk USSR, 5-15 August, 1991; Krasnoyarsk USSR, 1991; pp 135-139), oxidation using boric anhydride as an inhibitor of diamond oxidation (Chiganov, A. S., Selective Inhibition of the Oxidation of Nanodiamonds for Their Cleaning. Physics of the Solid State 2004, 46, (4), 595-787), and ozone-enriched air oxidation (Li, L.; Davidson, J. L.; Lukehart, C. M., Surface functionalization of nanodiamond particles via atom transfer radical polymerization. Carbon In Press, DOI:10.101 6/j.carbon.2006.02.023) also require the use of either toxic and aggressive substances or supplementary catalysts which result in an additional contamination or a significant loss of the diamond phase.

Purification techniques currently in use are based upon different reactivity of diamond and non-diamond carbon species towards oxidizers. Liquid phase oxidizers are usually employed, such as HNO₃, HClO₄, H₂SO₄, H₂O₂, aqueous and acidic solutions of NaClO₄, CrO₃, K₂Cr₂O₇ ,and the like. Liquid phase oxidation offers high local concentrations of oxidizer, which in turn provide high reaction rates and the possibility of controlling the entire nanodiamond manufacturing process by the liquid oxidizer concentration. Liquid phase oxidation also permits simultaneous dissolution of metal impurities.

Unfortunately, liquid phase oxidation suffers from many drawbacks. For example, liquid phase oxidation requires special corrosion-resisting equipment for processing, storing and transporting aggressive liquid oxidizers. Such equipment is often operated under high pressures and temperatures [V. Yu. Dolmatov, Ultradisperse Detonation Synthesis Diamonds, S. Petersburg, 2003]. Oxidation with acids, salts or oxides gives rise to sources of impurities in the nanodiamond such as nitrogen- and sulfur-containing compounds, chlorine, chromium, and the like, which subsequently need to be removed using additional purification steps. The environmental issues arising from the use of aggressive oxidizers, heavy metal compounds, or both, are additional disadvantages of current nanodiamond purification technologies.

Several alternative purification techniques have been proposed to overcome the disadvantages of liquid phase oxidation processes. For example, catalyst assisted air oxidative purification has been proposed in [Gubarevich T. M., Sataev R. R., Dolmatov V. Yu., Chemical purification of ultradisperse diamonds //Proc. of the 5th All-Union Meeting on Detonation. Krasnoyarsk USSR, 5-15 August 1991, V.1, p.135-139]. This technique uses air bubbling through the water suspension of nanodiamond in the presence of catalyst favoring the oxidation of non-diamond carbon. The need for the catalyst to selectively oxidize non-diamond carbon is the main disadvantage of this technique. The catalyst itself can be expensive and the particles of catalyst can contaminate the product. Gas-solid oxidation methods have also been developed by [Chiganov, A. S. et al, in Method For Cleaning Detonation Diamonds Russian Patent No. RU2004491, 15 Dec. 1993], which describes air oxidation of nanodiamond-bearing soot using boric anhydride as an inhibitor of diamond phase oxidation to selectively remove non-diamond carbon at temperatures in the range of from 300 to 550° C. Unfortunately this process contaminates the product with boron—an element which itself is extremely difficult to remove from the nanodiamond.

Ozone enriched air has been proposed as an alternative oxidizer for purification of nanodiamond according to Pavlov, E. V., et al., in Method For Removal Of Impurity Of Non-Diamond Carbon And Device For Its Realization, Russian Pat. No. RU2019502, 15 Sep. 1994. The gas-solid process proposed involves blowing ozone-air mixture through the nanodiarnond-bearing soot at temperatures 150-400° C. This process requires the use of ozone which is toxic, aggressive and difficult to handle.

Air oxidation has thus far not been considered feasible (Chiganov, A. S., Selective Inhibition of the Oxidation of Nanodiamonds for Their Cleaning Physics of the Solid State 2004, 46, (4), 595-787). Accordingly, there is a long sought need in the nanodiamond field to determine oxidation conditions for purifying ND without a significant loss of the diamond phase. In addition, there is an urgent need to develop nanodiamond purification procedures that overcome many of the disadvantages of the liquid-solid oxidation techniques mentioned above. For example, there is an urgent need to provide a nanodiamond purification process that is relatively simple to use, is safe for plant workers, avoids the use of highly corrosive materials, and is relatively benign to the environment.

### SUMMARY OF THE INVENTION

The general description and the following detailed description are exemplary and explanatory only and are not restrictive of the invention, as defined in the appended claims. Other aspects of the present invention will be apparent to those skilled in the art in view of the detailed description of the invention as provided herein.

In some aspects, the present invention provides processes for increasing the sp-3 diamond carbon fraction of a nanodiamond composition, comprising: providing a nanodiamond composition comprising sp-3 carbon and sp-2 carbon; and heating the nanodiamond composition in the presence of gaseous molecular oxygen to a temperature in the range of from about 375° C. to about 630° C.

In other aspects, the present invention provides processes for increasing the sp-3 diamond carbon fraction of a nanodiamond composition, consisting essentially of: heating a nanodiamond composition comprising sp-3 diamond carbon and sp-2 carbon in the presence of gaseous molecular oxygen to a temperature in the range of from about 375° C. to about 630° C.

The present invention also provides nanodiamond compositions comprising a plurality of nanodiamond particles comprising greater than about 95 percent of sp-3 diamond carbon based on total sp-3 carbon and sp-2 carbon, the plurality of nanodiamond particles having an average particle size in the range of from about 1 nm to about 30 nm. The disclosed compositions can be used either alone or in combination with other materials for use in coatings, abrasives, oil additives, rheology modifiers, composite materials, cleaning agents, chromatographic media, and the like

In some aspects, the present invention provides methods of decreasing the degree of aggregation in a nanodiarnond composition, comprising: providing a nanodiamond aggregate composition comprising a plurality of nanodiamond aggregates having an average diameter in the range of from about 10 nm to about 100,000 nm, the aggregates comprising a plurality of nanodiamond particles having an average diameter in the range of from about 1 nm to about 30 nm; and heating the nanodiamond aggregate composition in the presence of gaseous molecular oxygen to a temperature in the range of from about 375° C. to about 630° C. to give rise to a reduction in the average diameter of the aggregates.

In other aspects, the present invention provides methods of increasing the degree of aggregation in a nanodiamond composition, comprising: heating a nanodiamond composition in the presence of gaseous molecular oxygen to a temperature in the range of from about 375° C. to about 630° C. to give rise to production of oxygen-containing bridge structures of the type nanodiamond-COO-nanodiamond, nanodiamond-O-nanodiamond, nanodiamond-C(═O)-nanodiamond, or any combination thereof, wherein the bridge structures give rise to nanodiamond aggregates having an average diameter in the range of from about 10 nm to about 100,000 nm, the aggregates comprising a plurality of nanodiamond particles having an average diameter in the range of from about 1 nm to about 30 nm.

The present invention also provides processes for increasing the sp-3 diamond carbon fraction of a nanodiamond composition, comprising: providing a nanodiamond composition comprising sp-3 carbon and sp-2 carbon; and heating the nanodiamond composition in the presence of a gaseous oxidizing agent other than molecular oxygen or ozone, a plasma, or any combination thereof, to a temperature in the range of from about 25° C. to about 900° C.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 depicts non-isothermal thermogravimetric analysis (TGA) of nanodiamond (ND) samples (a) and carbon black powder (PureBlack), UD50 and their mixture (b) in air; the graphs are normalized by the sample weight at 200° C., the temperature at which physisorbed water and organic impurities are mostly removed from the diamond surface, but the oxidation of carbon does not occur;

FIG. 2 depicts UV (325 nn) Raman spectra of UD50 after oxidation at 375, 400, 425 and 450° C. for 5 h in air (a) and comparison of UD90IUD98 before and after oxidation for 5 h at 425° C. (b); a substantial enhancement of the diamond band after oxidation is evident for all ND samples and is apparently due to removal of graphitic carbon;

FIG. 3 depicts C K-edge XANES spectra of UD50, UD90, and UD98 before and after oxidation for 5 h at 425° C. in air; reference XANES spectra of microcrystalline diamond and highly ordered pyrolitic graphite (HOPG) are shown for comparison; substantial decrease in the intensity of 1 sπ* peak at ˜284.5 eV and correspondingly lower content of sp² carbon in oxidized ND is evident;

FIG. 4 depicts FTIR spectra of UD50, UD90, and UD98 samples before and after oxidation for 5 h at 425° C. in air; a spectrum of oxidized UD90 which was annealed for 2 h at 800° C. in hydrogen (20 ml/min) is shown to demonstrate control of the surface chemistry of ND after oxidation;

FIG. 5 provides HRTEM images of (a, b) UD50 and (c, d) UD90 before and after oxidation for 5 h at 425° C. in air; (e, f) HyperChem molecular models of ND (e) before and (f) after oxidation;

FIG. 6 depicts low resolution TEM image of nanodiamond particles of the oxidized UD90 on a lacey carbon film;

FIG. 7 depicts optical images of UD50, UD90, and UD98 before and after oxidation for 5 h at 425° C. in air;

FIG. 8 depicts Table 1 illustrating carbon nanostructures and listing selected physical properties of the investigated samples;

FIG. 9 depicts Table 2 listing results of the sp2/sp³ content analysis of ND samples by XANES before and after 5-h oxidation at 425° C. in air; data obtained on a reference microcrystalline diamond powder and HOPG are shown for comparison.

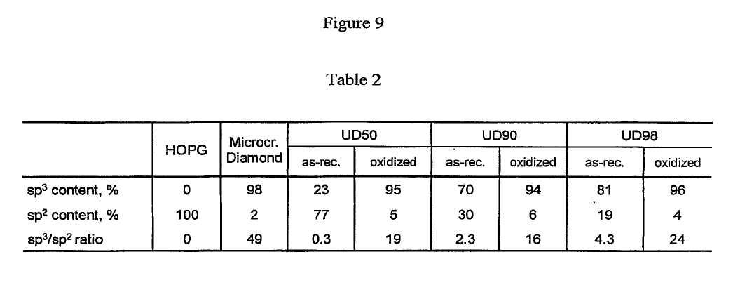

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an;” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. The term “plurality” means two or more of something. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

Nanodiamond Synthesis. Attractive properties of fullerenes and carbon nanotubes (CNTs) explored extensively in the past two decades have triggered a new wave of experimental and theoretical studies on all kinds of nanocarbons (Shenderova, O. A.; Zhimov, V. V.; Brenner, D. W., Carbon Nanostructures. Critical Reviews in Solid State and Materials Sciences 2002, 27, (3-4), 227-356; Gogotsi, Y., Carbon Nanomaterials CRC Press: Boca Raton, 2006.). Nanocrystalline diamond, a very promising carbon nanomaterial discovered in the early 1960s in the former Soviet Union, has received much less attention, but the interest in it has been quickly increasing in the past few years (Gruen, D. M.; Shenderova, O. A.; Vul, A. Y., Synthesis, Properties and Applications of Ultrananocrystalline Diamond. Springer: Dordrecht, 2005; Dolmatov, V. Y., Detonation synthesis ultradispersed diamonds: properties and applications. Russian Chemical Reviews 2001, 70, (7), 607-626.). Nanocrystalline diamond can be produced either as thin films using chemical vapor deposition (CVD) techniques or as powder by the detonation of carbon-containing explosives such as trinitrotoluene (TNT) and hexogen in a steel chamber. Both techniques have been the focus of several recent reviews (Shenderova, O. A.; McGuire, G., Nanocrystalline Diamond. In Nanomaterials handbook, Gogotsi, Y., Ed. CRC Press: Boca Raton 2006; pp 203-237; Danilenko, V. V., Synthesis and Sintering of Diamond by Detonation Energoatomizdat, 2003 (in Russian); Gruen, D. M., Nanocrystalline diamond films. Annual Review of Materials Science 1999, 29, 211-259; Dolmatov, V. Y., Ultradisperse diamonds of detonation synthesis: production, properties and applications State Polytechnical University: St. Petersburg, 2003.). While nanodiamond films are undoubtedly attractive as biocompatible, smooth, and wear resistant coatings, it is the nanodiamond powder that has the potential to achieve truly widespread use on a scale comparable to that of CNTs.

Processes for increasing the sp-3 diamond carbon fraction of a nanodiamond composition, include, or consist essentially of, heating a nanodiamond composition comprising sp-3 carbon and sp-2 carbon in the presence of gaseous molecular oxygen to a temperature in the range of from about 375° C. to about 630° C. A suitable nanodiamond composition can be in the form of a powder, although other suitable forms can be used. Suitable powders, for example, have a plurality of nanodiamond particles characterized as having an average diameter in the range of from about 1 nm to about 30 nm, or in the range of from about I nm to about 20 nm, or in the range of from about 2 nm to about 9 nm, or in the range of from about 3 nm to about 8 nm, or even in the range of from about 4 nm to about 7 nm.

Prior to heating, at least a portion of the ND particles include sp-3 carbon forming diamond phase cores encased by non-diamnond phase sp-2 carbon. The non-diamond phase sp-2 carbon encasing the ND cores typically oxidizes away during heating to increase the sp-3 diamond carbon fraction of the ND composition. Other types of non-diamond carbon are also capable of oxidizing in the presence of molecular oxygen at these conditions. Because non-diamond carbon is oxidized (i.e., burned) away, the step of heating changes the average particle size of the ND particles, for example by reducing or increasing the average particle size of the ND particles. Typically ND particles are reduced in size, and accordingly ND particle size can be controlled by heating in this fasion. By controlling the temperature of oxidation, the sp-2 carbon according to the present invention is selectively oxidized so that the weight fraction of sp-3 carbon after heating is greater than the weight fraction of sp-3 carbon before heating.

Suitable temperatures for heating the ND composition in the presence of molecular oxygen can be anywhere in the range of from about 375° C. to about 630° C., more suitably the ND composition is maintained at a temperature in the presence of molecular oxygen between about 375° C. and about 450° C. for a time sufficient to increase the percent of sp-3 diamond carbon in the ND composition to greater than 50 percent. Other temperature ranges are also suitable, for example, the temperature of the ND composition can vary or be held essentially constant (aside from heating to such as set temperature, and cooling to recover the sample). Temperatures are often held fairly constant, for example between about 375° C to about 630° C., or between about 375° C. and about 600° C., or between about 375° C. and about 550° C., or from between about 375° C. and about 500° C., or from about 375° C. and about 450° C., or from about 385° C. and about 440° C., or even at a temperature between about 395° C. and about 435° C. for a time sufficient to increase the percent of sp-3 diamond carbon in the ND composition to more than 50 percent.

Typically the lower the temperature the longer the time is needed to treat the ND composition to achieve such an increase in sp-3 content. Likewise, the higher the temperature the faster it takes the molecular oxygen to oxidize the sp-2 carbon. Although almost any conceivable time is envisioned, the time sufficient to increase the percent of ND in the ND composition to more than 50 percent is usually in the range of from about 1 second to about two days, more likely in the range of from about 10 seconds to about 10 hours, and even more suitably in the range of from about 100 seconds to about 6 hours, and even more suitably in the range of from about 15 minutes to about 4 hours, and further suitably in the range of from about 30 minutes to about 3 hours.

Suitable gaseous molecular oxygen can be provided to the process using purified oxygen, an oxygen/inert gas mixture, ambient air, or any combination thereof. Other non-reactive gases can be present in the process, for example nitrogen, helium, neon, argon, krypton, xenon, or any combination thereof.

Heating the ND composition can occur at atmospheric pressure, at a pressure less than atmospheric pressure, or greater than atmospheric pressure, or any combination thereof Suitable ND samples typically exhibit the sp-2 carbon present in the form of one or more non-diamond carbon phases in the ND composition. For example, the non-diamond carbon can comprise carbon onion, carbon fullerene shell, amorphous carbon, graphitic carbon, or any combination thereof. During the heating process, at least a portion of the non-diamond carbon is oxidized, suitably at least about 50 percent by weight, and even at least about 90 percent by weight, and oftentimes substantially all of the non-diamond phase is oxidized.

Other process steps can also be included, for example the process can further include the step of monitoring the composition while heating the ND composition. Types of monitoring can include the weight, the chemical composition, or both, of the ND composition while heating the ND composition.

Suitable ND compositions comprise less than about 85 percent sp-3 diamond carbon based on total weight of the ND composition prior to heating, and greater than about 90 percent sp-3 diamond carbon based on total weight of the ND composition after heating.

The ND compositions may further comprise one or more non-carbon impurities. In these cases, such non-carbon impurities may contain a metal that functions as a catalytic site suitable for enhancing carbon oxidation. Such metals that may be suitable for enhancing carbon oxidation may originate in the synthesis of ND, for example, during detonation synthesis. As described further below in the examples and other illustrative embodiments, iron metal particles originating from the interior surfaces of the detonation chambers commonly are found in ND compositions. In such cases, the iron content of the ND composition can be in the range of from about 0.005 atomic percent to about 5 atomic percent, based on total percent of the ND composition. When catalytic particles that assist oxidation of sp-2 carbon are present, the temperature of the ND composition can be maintained at a temperature lower than 630° C., commonly between about 375° C. and about 450° C., for a time sufficient to increase the percent of sp-3 diamond carbon in the ND composition to more than 50 percent. Other suitable temperature ranges for increasing the sp-3 diamond carbon content in ND containing catalytic particles include from about 385° C. and about 440° C., or even between about 395° C. and about 435° C. In such cases where metals are present in the ND after heating, the processes may further comprise the step of contacting the ND composition, with an acidic solution to remove one or more metal impurities in the ND composition. In certain cases when the ND composition is substantially free of non-carbon impurities prior to heating, the temperature of the ND composition can be maintained at a temperature between about 450° C. and about 630° C. for a time sufficient to increase the percent of sp-3 diamond carbon in the ND composition to more than 50 percent.

The sp-3 carbon content and the sp-2 carbon content can be determined using a variety of analytic techniques, such as C¹³ nuclear magnetic resonance (NMR), Raman spectroscopy, HRTEM, and XANES. These techniques are described in more detail further below. Such various analytical techniques can be further incorporated into the processes as described herein for the purposes of monitoring the sp-3 and sp-2 contents before heating, during heating, after heating, or any combination thereof. Prior to heating the sp-2 carbon content of some ND compositions can be greater than about 6 percent, and after heating the sp-2 carbon content is usually less than about 6 percent, based on total sp-2 carbon and sp-3 carbon. Correspondingly, the sp-3 content before heating is lower than about 94 percent and greater than about 94 percent after heating. Alternatively, the ND composition can be characterized in terms of the ratio of sp-3 carbon to sp-2 carbon. Here, the ND composition is heated for the purpose of increasing the ratio of sp-3 carbon to sp-2 carbon, the ratio typically increasing from a value less than about 4, or even less than about 3, or even less than about 1, to a ratio at least about 15, or 18, or 21, or even higher than about 24. Accordingly, the processes of the present invention are capable of increasing the ratio of sp-3 carbon to sp-2 carbon after heating to at least about 5 times, or even at least about 10 times, or even at least about 20 times, greater then the ratio of sp-3 carbon to sp-2 carbon before heating.

The present invention also provides nanodiamond compositions comprising a plurality of nanodiamond particles comprising greater than about 95 percent of sp-3 diamond carbon based on total sp-3 carbon and sp-2 carbon, the plurality of nanodiamond particles having an average particle size in the range of from about 1 nm to about 30 nm. As described hereinabove, the nanodiamond compositions are characterized wherein the sp-2 carbon content is less than about 4 percent based on total sp-3 and sp-2 carbon content. Alternatively, the ND can be characterized wherein the ratio of sp-3 carbon to sp-2 carbon is at least about 20. The nanodiamond compositions may further have nanodiamond particles that further comprise one or more reactive oxygen bearing functional groups externally disposed on their surface. In such cases the oxygen bearing functional groups can be used for the purposes of increasing the polarity of the ND which is useful for preparing ND formulations useful in a variety of applications. Alternatively, the oxygen-bearing functional groups can be further reacted with any of a variety of functional moieties, such a non-polar alkyl groups, polar and non-polar oligomers, polymers, and the like, for a variety of applications. The disclosed compositions can be used either alone or in combination with other materials for use in coatings, abrasives, oil additives, rheology modifiers, composite materials, cleaning agents, chromatographic media, and the like.

Methods of decreasing the degree of aggregation in a nanodiamond composition are also provided which comprise providing a nanodiamond aggregate composition comprising a plurality of nanodiamond aggregates having an average diameter in the range of from about 10 nm to about 100,000 nm, the aggregates comprising a plurality of nanodiamond particles having an average diameter in the range of from about 1 nm to about 30 nm; and heating the nanodiamond aggregate composition in the presence of gaseous molecular oxygen to a temperature in the range of from about 375° C. to about 630° C. to give rise to a reduction in the average diameter of the aggregates. ND aggregates are suitably characterized using any type of particle sizing instrument, such as laser light scattering.

The degree of aggregation of NDs can also be controlled. Methods of increasing the degree of aggregation in a nanodiamond composition include: heating a nanodiamond composition in the presence of gaseous molecular oxygen to a temperature in the range of from about 375° C. to about 630° C. to give rise to production of oxygen-containing bridge structures of the type nanodiarnond-C(═O)O-nanodiamond, nanodiamond-O-nanodiamond, nanodiarnond-C(═O)-nanodiamond, or any combination thereof, wherein the bridge structures give rise to nanodiamond aggregates having an average diameter in the range of from about 10 nm to about 100,000 nm, the aggregates comprising a plurality of nanodiamond particles having an average diameter in the range of from about 1 nm to about 30 nm. Aggregates are suitably measured using a particle size analyzer, for example, one based on laser light scattering.

Other methods besides using molecular oxygen are also provided for increasing the sp-3 diamond carbon fraction of a nanodiamond composition. For example, suitable processes include, or consist essentially of, heating a nanodiamond composition in the presence of a gaseous oxidizing agent other than molecular oxygen or ozone, or a plasma oxidizing agent, or both, to a temperature in the range of from about 25° C. to about 900° C. Suitable gaseous oxidizing agents other than molecular oxygen or ozone include elemental oxygen covalently bonded to one or more atoms other than oxygen. For example, any of a variety of small molecules comprising covalently bonded oxygen can be used. Suitable small molecules comprising covalently bonded oxygen atoms can include O—H, C═O, C—O bonds, and the like. Suitable small molecules comprising these types of bonds that can be used as a gaseous oxidizing agent include carbon dioxide, potassium hydroxide, water, or any combination thereof. When the process is operated using gaseous oxidizing agents, the ND composition is usually heated to temperature of at least about 375° C., or at least about 400° C., or at least about 450° C., or at least about 500° C., or at least about 550° C., or at least about 600° C., or at least about 650° C., or at least about 700° C., or at least about 750° C., or at least about 800° C., or at least about 850° C. Nanodiamond compositions may also be heated in the presence of the gaseous oxidizing agent and a non-reactive gas. Suitable non-reactive gas comprises nitrogen, helium, neon, argon, krypton, xenon, or any combination thereof.

Plasma oxidizing agents allow for the oxidation of sp-2 carbon at a variety of temperatures. Plasma oxidizing agents are suitably used at temperatures lower than about 375° C., or even lower than about 325° C., or even lower than about 275° C., or even lower than about 225° C., or even lower than about 175° C., or even lower than about 125° C., or even lower than about 75° C. Suitable plasma oxidizing agents include a hydrogen plasma, an argon plasma, an oxygen plasma, a helium plasma, or any combination thereof. Plasma methods and equipment are described in detail by Fridman, A. A., et al., in “Plasma Physics and Engineering”, published by CRC, 2004 (ISBN: 1560328487).

Applications of Nanodiamond Powders. The nanodiamond compositions and aggregates provided according to the present invention can be used in any of a variety of applications. Previously known methods of incorporating lower sp-3 purity NDs can be used for incorporating the NDs made according to the present invention into any of these applications.

Average nanodiamond particle sizes can be in the range of about 5-8 nm, although ranges as large as from about 1 nm to about 30 nm are possible. Due to a large number of unsatisfied surface atoms and a large surface/volume ratio, ND can exhibit a very high surface reactivity compared to other carbon nanostructures. ND nanocrystals might be able to combine an active surface, featuring a variety of chemically reactive moieties, with the favorable properties of macroscopic diamonds, including their extreme hardness and Young's modulus, chemical stability, biocompatibility, high thermal conductivity, and electrical resistivity, to name a few. ND can be used in composite materials (Sirotinkin, N. V.; Voznyakovskii, A. P.; Ershova, A. N., Model of formation of three-dimensional polyurethane films modified by detonation nanodiamonds. Physics of the Solid State 2004, 46, (4), 746-747), as an additive in cooling fluids (Davidson, J. L.; Bradshaw, D. T. Compositions with nano-particle size diamond powder and methods of using same for transferring heat between a heat source and a heat sink. U.S. Pat. No. 6,858,157B2, 2005), lubricants (Red'kin, V. E., Lubricants with ultradisperse diamond-graphite powder. Chemistry and Technology of Fuels and Oils 2004, 40, (3), 164-170), and electroplating baths (Dolmatov, V. Y., Detonation synthesis ultradispersed diamonds: properties and applications. Russian Chemical Reviews 2001, 70, (7), 607-626). Coarser (100 nm) fluorescent diamond powders may replace quantum dots as fluorescent probes for intracellular processes (Yu, S. J.; Kang, M. W.; Chang, H. C.; Chen, K. M.; Yu, Y. C., Bright fluorescent nanodiamonds: No photobleaching and low cytotoxicity. Journal of the American Chemical Society 2005, 127, (50), 17604-17605). A large number of other potential applications, including biocompatible composites, drug delivery, stable catalyst support, chemically resistant chromatographic materials with a tailorable surface, transparent coatings for optics (Gruen, D. M.; Shenderova, O. A.; Vul, A. Y., Synthesis, Properties and Applications of Ultrananocrystalline Diamond. Springer: Dordrecht, 2005), can also incorporate the NDs of the present invention. Most of these applications have previously been hindered due to their inability of the manufacturers to provide ND with well-controlled surface chemistry and the absence of a process that would achieve this control in a research laboratory. The NDs and methods of the current invention provided improved surface chemistry control and particle size control, as well as higher sp-3 diamond contents than previously available.

### EXAMPLES AND OTHER ILLUSTRATIVE EMBODIMENTS

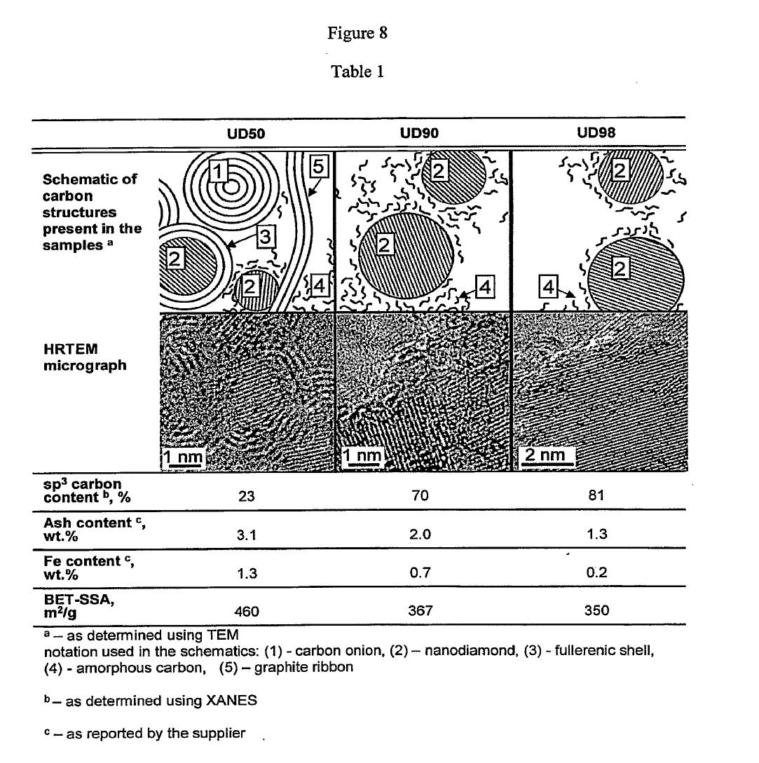

Materials. The ND used in this study was produced by detonation synthesis and supplied by NanoBlox Inc. (USA). FIG. 8, Table 1 summarizes selected properties and composition of the three samples (UD50, UD90, and UD98) used in our study. Black UD50 is the raw detonation soot containing non-diamond carbon structures such as amorphous carbon, carbon onions, fullerenic shells and graphite ribbons. The black color of the powder is related to the high content of sp² carbon. UD90 and UD98 samples were prepared by different multistage acidic purifications using nitric and sulfuric acids, and mainly consist of nanodiamond particles and amorphous carbon (FIG. 8, Table 1). In addition to sp² carbon, all powders contain metal impurities, mainly iron (FIG. 8, Table 1), often surrounded by carbon shells, as revealed by transmission electron microscopy (TEM).

Methods. Oxidative purification was done under isothermal conditions using a THM600 Linkam heating stage and a tube furnace, and under non-isothermal conditions using a thermobalance (Perkin Elmer TGA 7). Isothermal experiments included two steps: (i) rapid heating at 50 ° C./min to the selected temperature and (ii) isothermal oxidation for 5 h in ambient air at atmospheric pressure. The THM600 Linkam heating stage was calibrated by using the melting points of AgNO₃ (209° C.), tin (232° C.), KNO₃ (334° C.), and Ca(OH)₂ (580° C.,). In every case, the difference between the measured and expected melting point did not exceed 2° C. TGA analyses were conducted under a minimal ambient air flow of 40 ml/min in the temperature range between 25 and 800° C. A heating rate of 1° C./min was chosen for all experiments.

Characterization. Argon sorption analysis was done using Quantachrome Autosorb-1 at −195.8° C. The Brunauer-Emmet-Teller (BET) equation (Brunauer, S.; Emmett, P.; Teller, E., Adsorption of Gases in Multimolecular Layers. J. of Am. Chem. Soc. 1938, 60, 309-319) was used to evaluate the specific surface area (SSA) of ND.

Raman analysis of the initial and oxidized powders was conducted using a Renishaw 1000/2000 spectrometer with an excitation wavelength of 325 nm (He—Cd laser) in back-scattering geometry. In situ Raman studies were performed under 325 and 633 nm (He—Ne laser) excitation. Experimental details related to the in situ measurements have been described elsewhere (Osswald, S.; Flahaut, E.; Ye, H.; Gogotsi, Y., Elimination of D-band in Raman spectra of double-wall carbon nanotubes by oxidation. Chemical Physics Letters 2005, 402, (4-6), 422-427; Yushin, G. N.; Osswald, S.; Padalko, V. I.; Bogatyreva, G. P.; Gogotsi, Y., Effect of sintering on structure of nanodiamond. Diam. Related Mater. 2005, 14, (10), 1721-1729).

Soft x-ray absorption near-edge structure (XANES) spectroscopy experiments were performed at undulator beamline 8.0 at the Advanced Light Source (ALS) at Lawrence Berkeley National Laboratory (LBNL). Spectra were obtained by measuring the total electron yield by monitoring the total sample photocurrent. The incoming radiation flux was monitored by measuring the total photocurrent produced in a highly transmissive Au mesh inserted into the beam. All XANES spectra were normalized to the Au mesh photocurrent. The monochromator was calibrated by aligning the π* resonance in the carbon K-edge of highly oriented pyrolytic graphite (HOPG) to 285.4 eV. After a linear background subtraction, all spectra were normalized to the post-edge step heights. The relative changes in the sp³-bonded carbon content of ND samples were estimated from XANES spectra using the procedure described in Refs. Kulik, J.; Lempert, G. D.; Grossman, E.; Marton, D.; Rabalais, J. W.; Lifshitz, Y., sp(3) content of mass-selected ion-beam-deposited carbon films determined by inelastic and elastic electron scattering. Physical Review B 1995, 52, (22), 15812-15822; Gago, R.; Jimenez, I.; Albella, J. M.; Climent-Font, A.; Caceres, D.; Vergara, I.; Banks, J. C.; Doyle, B. L.; Terminello, L. J., Bonding and hardness in nonhydrogenated carbon films with moderate sp(3) content. Journal of Applied Physics 2000, 87, (11), 8174-8180, where the relative intensity ratios of π*/σ* states in ND samples and in HOPG (pure sp2-bonded carbon) are compared:

$$\% {sp}_{ND}^{2} \approx \frac{{( {π}^{*} / {σ}^{*} )}_{ND}}{{( {π}^{*} / {σ}^{*} )}_{HOPG}} ; \% {sp}_{ND}^{3} = 100 \% - \% {sp}_{ND}^{2} \qquad ( 1 )$$

For the numerical integration, the energy ranges of 282-287 eV and 293-302 eV were used to represent the π* and σ* states' contributions to the XANES spectra.

JEOL 2010F field emission TEM operating at accelerating voltage of 100 kV and 200 kV was used for high-resolution imaging of ND particles. To minimize the in situ transformation of diamond to graphitic carbon under the electron beam, exposure of ND samples to the electron beam was limited to five and one minutes for 100 kV and 200 kV, respectively. TEM samples were prepared by dispersing ND in isopropyl alcohol over a copper grid coated with a lacey carbon film.

Fourier transform infrared (FTIR) spectra were collected using a Digilab FTIR spectrometer equipped with a Digilab UMA 600 microscope evading any sample preparation for the measurements.

Results—Thermogravimetric analysis. In order to determine the appropriate temperature range for the selective oxidation of non-diamond carbon, non-isothermal TGA was performed in air. FIG la compares the oxidation behavior of the ND samples and shows differences in the oxidation rate and the temperature at which the maximum weight loss occurs. At temperatures below 375° C. the oxidation is inhibited or its rate is too low to allow noticeable removal of carbon within a reasonable time frame (range I). At temperatures above 450° C., all kinds of carbon in the sample, including amorphous, graphitic and diamond phases are quickly oxidized (range III). In the intermediate temperature zone (range II), the oxidation rate shows substantial differences between the samples: while the mass of relatively pure UD98 does not change noticeably, UD50 with a substantial graphitic content (FIG. 8, Table 1) shows a significant weight loss.

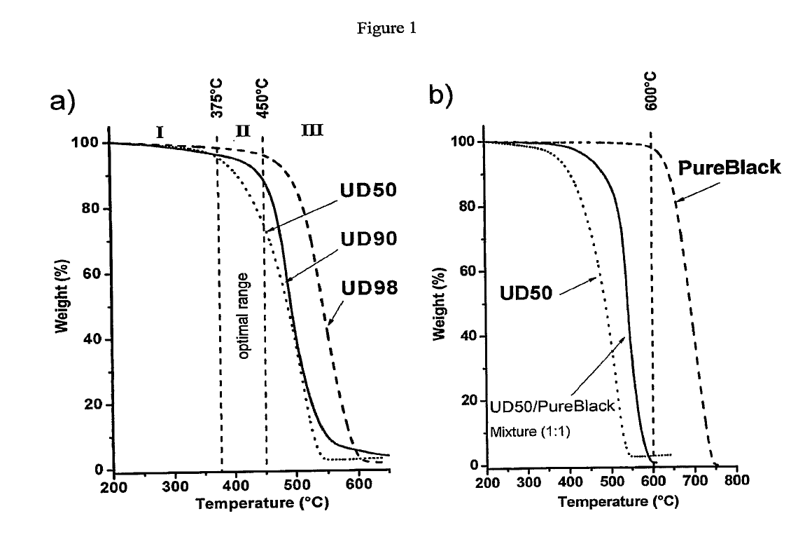

Metal and metal oxide impurities present in all ND samples also affect TGA results and account for a noticeable difference in the oxidation of UD90 and UD98 (FIG. 1a), which have similar contents of sp²-bonded carbon (FIG. 8, Table 1) but show some variation in the level of non-carbon impurities. In order to confirm the effect of iron on the oxidation kinetics of carbon, we performed TGA analysis of metal-free nano-sized amorphous carbon black powder (PureBlack) with and without an addition of UD50 in the mixture (1: 1) (FIG. 1b). PureBlack alone demonstrated resistance to oxidation at temperatures below ˜600° C. However, the mixed powder was fully oxidized before even reaching 600° C. Iron particles, the major contaminants of ND, are well known for their catalytic behavior towards reactions between molecular oxygen and carbon (Landi, B. J.; Cress, C. D.; Evans, C. M.; Raffaelle, R. P., Thermal oxidation profiling of single-walled carbon nanotubes. Chemistry of Materials 2005, 17, (26), 6819-6834; Park, T. J.; Banerjee, S.; Hemraj-Benny, T.; Wong, S. S., Purification strategies and purity visualization techniques for single-walled carbon nanotubes. Journal of Materials Chemistry 2006, 16, (2), 141-154; Xu, X. Y.; Li, X. G., Preparation of single crystalline V₆O₁₃ nanobelts. Chinese Chem. Lett. 2005, 16, (2), 249-252). Metals and metal oxides encapsulated into amorphous and graphitic carbon shells in as-produced soot could become accessible to liquid oxidizers only after carbon shells are removed by preceding acid treatments (Gruen, D. M.; Shenderova, O. A.; Vul, A. Y., Synthesis, Properties and Applications of Ultrananocrystalline Diamond. Springer: Dordrecht, 2005; Aleksenskii, A. E.; Baidakova, M. V.; Vul, A. Y.; Siklitskii, V. I., The structure of diamond nanoclusters. Physics Of The Solid State 1999, 41, (4), 668-671; Brenner, D. W.; Shenderova, O. A.; Areshkin, D. A.; Schall, J. D.; Frankland, S. J. V., Atomic modeling of carbon-based nanostructures as a tool for developing new materials and technologies. Cmes-Computer Modeling in Engineering & Sciences 2002, 3, (5), 643-673). The limited efficiency of wet chemistry in removing sp² carbon thus strongly affects the removal of non-carbon impurities and emphasizes the importance of using alternative purification techniques.

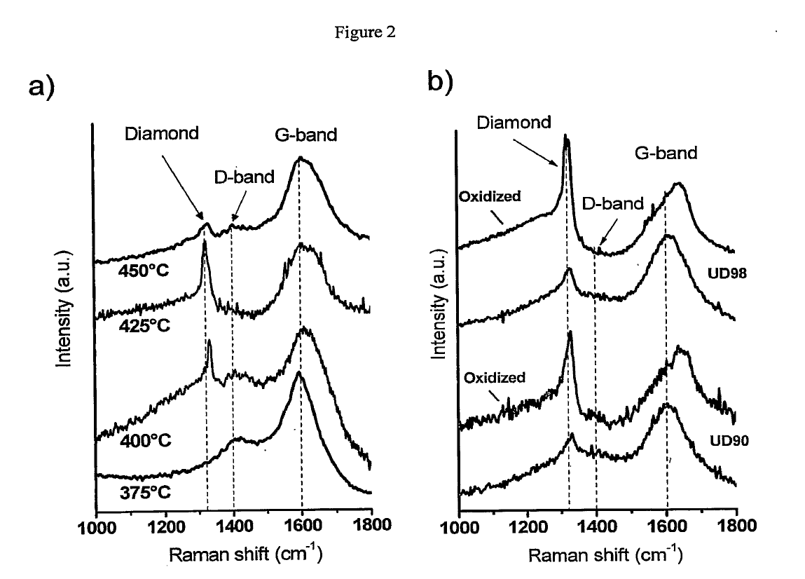

UV Raman spectroscopy. Oxidation temperature and time parameters were determined by oxidizing ND for 5 h at different temperatures between 375 and 450° C. with 10° C. steps. Samples were characterized using UV-Raman spectroscopy. FIG. 2a shows results for UD50. The raw unpurified powder was chosen because of its large content of non-diamond carbon and more evident spectral changes. The UV-Raman spectrum of ND shows three characteristic features: the disorder induced double-resonance D band at ˜1400 cm⁻¹ (Ferrari, A. C.; Robertson, J., Raman spectroscopy of amorphous, nanostructured, diamond-like carbon, and nanodiamond. Philosophical Transactions of the Royal Society ofLondon Series a-Mathematical Physical and Engineering Sciences 2004, 362, (1824), 2477-2512; Reich, S.; Thomsen, C., Raman spectroscopy of graphite. Philosophical Transactions of the Royal Society of London Series a-Mathematical Physical and Engineering Sciences 2004, 362, (1824), 2271-2288), the upshifted graphite G band at 1600 cm⁻¹ ) and the downshifted and broadened, with respect to the Raman mode of single crystal diamond (1332 cm⁻¹), diamond peak at ˜1325 cm⁻¹ (Yushin, G. N.; Osswald, S.; Padalko, V. I.; Bogatyreva, G. P.; Gogotsi, Y., Effect of sintering on structure of nanodiamond. Diam. Related Mater. 2005, 14, (10), 1721-1729; Prawer, S.; Nemanich, R. J., Raman spectroscopy of diamond and doped diamond. Phil. Trans. R. Soc. Lond. A 2004, 362, 2477-2512; Prawer, S.; Nugent, K. W.; Jamieson, D. N.; Orwa, J. O.; Bursill, L. A.; Peng, J. L., The Raman spectrum of nanocrystalline diamond. Chem. Phys. Lett. 2000, 332, 93-97). (FIG. 2a). The lower oxidation temperature (375° C.) was not sufficient to remove amorphous and graphitic carbon in five hours, but may be able to if heated for longer times, such as two days. Because of the much larger Raman scattering cross-section of graphite compared to diamond, the Raman spectrum is dominated by the Raman features of sp²-bonded carbon (D and G bands), which overshadow the diamond band. Fullerenic shells enclose the diamond crystals and further weaken their Raman signal. At temperatures above 450° C., oxidized powders become inhomogeneous with respect to the ratio of diamond and non-diamond carbon phases. The Raman intensities of the diamond peak at ˜1325 cm⁻¹ and G-band at ˜1600 cm⁻¹ vary strongly when comparing the UV Raman spectra recorded at different sample spots (data not shown), suggesting that all types of carbon are oxidized simultaneously leading to an inhomogeneous diamond distribution. When using oxidation temperatures between the extremes (375-450° C.), non-diamond carbon can be removed selectively and a significant loss of the diamond can be avoided. The Raman spectrum of the UD50 oxidized at 400° C. demonstrates a substantially enhanced diamond signal. The intensity ratio between the diamond band and the G band in the Raman spectrum of ND reaches a maximum within this temperature range, indicating the best conditions for the ND purification, which maximize the diamond content and minimize the amount of both amorphous and graphitic carbon.

In situ Raman spectroscopy was used for the improvement of the purification process (data not shown). While the optimal oxidation temperature could be affected by both the sample composition and the experimental conditions, temperatures within 400-430° C. range were found to be most favourable in the present study. Small changes in the oxidation temperature within the given range can be used to find a compromise between the higher purification rate (lower time and costs) and the acceptable weight loss due to minor oxidation of the diamond phase.

The determined oxidation conditions were then used to purify larger amounts of ND in a chamber furnace to simulate industrial conditions. The weight loss in these experiments was very close to the amount of sp² carbon in the samples (FIG. 8, Table 1). FIG. 2b compares the UV-Raman spectra of the as-received and the purified by 5-h oxidation at 425° C. ND samples. The Raman spectra of the as-received UD90 and UD98 show a lower intensity of D-band as compared to UD50 and presence of a nanodiarnond peak. The oxidation leads to a significant increase in the relative intensity of the diamond peak in all the samples, the most dramatic changes being observed in UD50 (FIG. 2a). While air oxidation evidently removes fullerenic shells and other sp²-bonded carbon impurities from the samples, it also influences the surface chemistry and thus affects the shape of the Raman peaks. The appearance of a shoulder at 1140-1300 cm⁻¹ as well as the strong upshift of the G peak to 1640 cm⁻¹ in the oxidized samples could be the manifestations of bond formation of carbonyl oxygen containing flnctional groups (e.g. ketone) on sp²or sp³-bonded carbon (Ferrari, A. C.; Robertson, J., Raman spectroscopy of amorphous, nanostructured, diamond-like carbon, and nanodiamond. Philosophical Transactions of the Royal Society of London Series a-Mathematical Physical and Engineering Sciences 2004, 362, (1824), 2477-2512). A similar upshift of the G band was also observed in disordered diamond like carbon (also called tetrahedral carbon) with a high content of sp³-bonded carbon and explained by resonance phenomena (Ferrari, A. C.; Robertson, J., Raman spectroscopy of amorphous, nanostructured, diamond-like carbon, and nanodiamond. Philosophical Transactions of the Royal Society of London Series a-Mathematical Physical and Engineering Sciences 2004, 362, (1824), 2477-2512). However we believe that since ND surface atoms account for over 20% of total atoms in ND particles below 5 nm, surface functionalities are responsible for this peak and a FTIR confirmation of this statement will be presented in the following section.

X-ray absorption near-edge structure spectroscopy. XANES allowed the quantification of the sp³ content in ND samples and understanding about their bonding structure. As compared to electron energy loss spectroscopy (EELS), XANES is a more quantitative technique that offers a better spectral resolution, minimizes the sample damage, and allows one to obtain an averaged signal from the macroscopic sample. The C K-edge XANES spectra reflect angular-momentum-selected electronic transitions from the C 1s core level into the conduction band. Hence, if possible core-hole relaxation and electron correlation effects and higher multipole transitions are ignored, XANES spectra map the p-projected density of empty C-related states above the Fermi level (Stöhr, J., NEXAFS Spectroscopy Springer: Berlin, 2003).

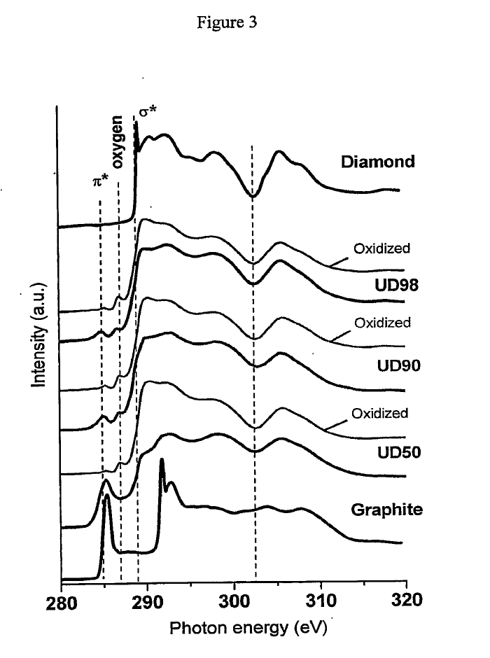

FIG. 3 compares the XANES spectra of graphite, microscrytalline diamond and all the ND samples before and after oxidation in air. The spectra of ND exhibit two peaks centered at 285.4 and 286.5 eV, and a broad band absorption with a threshold at ˜289 eV. The peak at 285.4 eV is assigned to the 1s→πC* transition of sp²-bonded carbon (Stöhr, J., NEXAFS Spectroscopy Springer: Berlin, 2003), while the ˜286.5 eV peak can be related to the chemisorbed oxygen (C═O) (Stöhr, J., NEXAFS Spectroscopy Springer: Berlin, 2003; Jaouen, M.; Tourillon, G.; Delafond, J.; Junqua, N.; Hug, G., A NEXAFS characterization of ion-beam-assisted carbon-sputtered thin films. Diam. Related Mater. 1995, 4, (3), 200-206). Our assignment of this peak is also supported by the correlation of its relative intensity with the intensity of peaks in the second order O K-edge at ˜272 eV (not shown). The broad peak with an absorption edge at ˜289 eV is related to the 1s→σ* transitions. Diamond lacks π* states and shows an absorption edge at 289 eV (1s→σ* of sp³-bonded C), while graphite shows two absorption edges at 284 eV (1s→π*) and 291 eV (1s→σ* of sp²-bonded C). The oxidation treatment of ND samples resulted in the substantial decrease of 1s→π* related transitions and a more pronounced second band gap dip of diamond at ˜302.5 eV, confirming Raman studies discussed above. Some increase in the oxygen-related peak intensities was also observed. The results of the semi-quantitative analysis of sp³-bonded carbon content in ND samples are presented in Table.2. Not only did oxidation in air decrease sp²-bonded carbon impurities in the ND (UD90 and UD98) samples pre-purified by acidic treatment by about five times, but it was also capable of selectively removing graphitic carbon in the soot sample (UD50), thus increasing the sp³/sp² ratio in this sample by nearly two orders of magnitude from 0.3 to 19 (Table.2). The purity of the oxidized UD98 is comparable to that of microcrystalline diamond. While some authors claimed a high content (>92%) of diamond in the ND powders, those conclusions were based on X-ray photoelectron spectroscopy (XPS) and X-ray diffraction (XRD) measurements of the diamond/graphite ratio (Huang, F.; Tong, Y.; Yun, S., Synthesis mechanism and technology of ultrafine diamond from detonation. Physics of the Solid State 2004, 46, (4), 616-619) and can not be considerable reliable, because XRD overestimates the diamond content and surface analysis techniques cannot provide good quantitative data for powdered materials. To the best of our knowledge, greater than about 95% sp³ carbon has never been found in ND samples by XANES or nuclear magnetic resonance (NMR) spectroscopy.

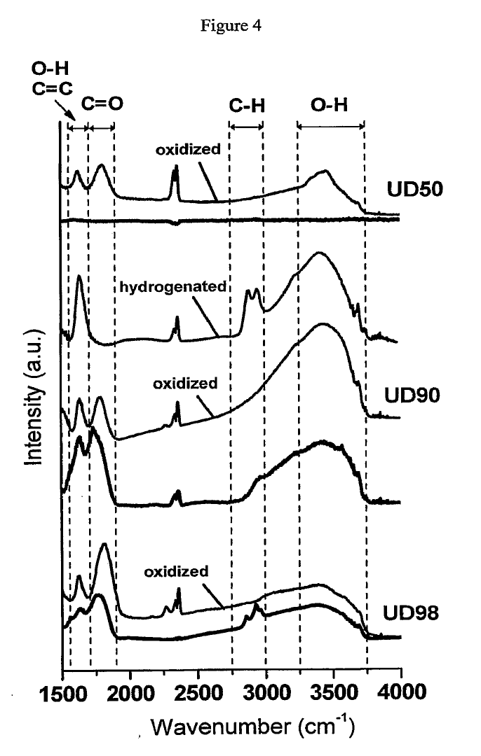

Fourier-transformed infrared spectroscopy. While XANES analysis was useful to distinguish between the different carbon species, FTIR spectroscopy was used to determine functional groups, adsorbed molecules and impurities on the surface of the carbon. The main features in the FTIR spectra of as-received powders (FIG. 4) are related to C═O (1740-1757 cm⁻¹), C-H (2853-2962 cm⁻¹) and O—H vibrations (3280-3675 cm⁻¹ stretch and 1640-1660 cm⁻¹ bend) which can be assigned to —COOH, —CH₂—, —CH₃ and —OH groups of chemically bonded and adsorbed surface species (Ji, S. F.; Jiang, T. L., Xu, K.; Li, S. B., FTIR study of the adsorption of water on ultradispersed diamond powder surface. Applied Surface Science 1998, 133, (4), 231-238; Jiang, T.; Xu, K., FTIR study of ultradispersed diamond powder synthesized by explosive detonation. Carbon 1995, 33, (12), 1663-1671; Kuznetsov, V. L.; Aleksandrov, M. N.; Zagoruiko, I. V.; Chuvilin, A. L.; Moroz, E. M.; Kolomichuk, V. N.; Likholobov, V. A.; Brylyakov, P. M.; Sakovitch, G. V., Study of Ultradispersed Diamond Powders Obtained Using Explosion Energy. Carbon 1991, 29, (4-5), 665-668). Black and strongly absorbing as-received UD50 shows no detectable FTIR vibrations due to the high content of graphitic and amorphous carbon structures. The comparison of FTIR spectra of purified and as-received powders reflects the conversion of a variety of surface functional groups into their oxidized derivatives. After oxidation, —CH₂— and —CH₃ groups are completely removed from UD90 and UD98, the amount of —OH groups is increased and C═O vibrations are upshifted by 20-40 cm⁻¹ indicating a conversion of ketones, aldehides and esters on the surface into carboxylic acids, anhydrides, or cyclic ketones. The most prominent changes in the surface termination after oxidation were found for UD50. Upon the removal of graphitic layers by oxidation, the surface of UD50 became accessible for chemical reactions and is immediately saturated with oxygen or oxygen-containing functional groups. The oxidized ND with controlled surface is thus ready for further modifications and functionalization procedures. We have demonstrated this by hydrogenating oxidized UD90 for 2 h in a hydrogen gas flow of 20 ml/min at 800° C. This led to complete disappearance of C═O vibrations in FTIR spectrum (FIG. 4), a drastic decrease of the oxygen peak in the XANES spectrum and an increase in the intensity of C—H vibrations in the FTIR spectrum, suggesting formation of hydrogen-terminated ND. The hydrogenated sample dissolved easily in non-polar solvents, such as toluene, while the oxidized sample could be easily dispersed in water and alcohols, but immediately deposited on the bottom of the vial in non-polar hydrocarbon solvents.

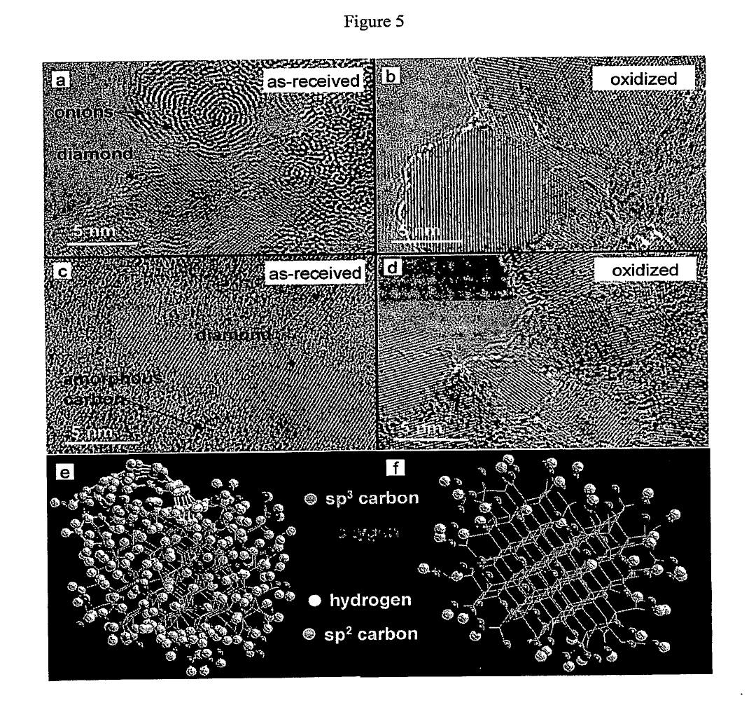

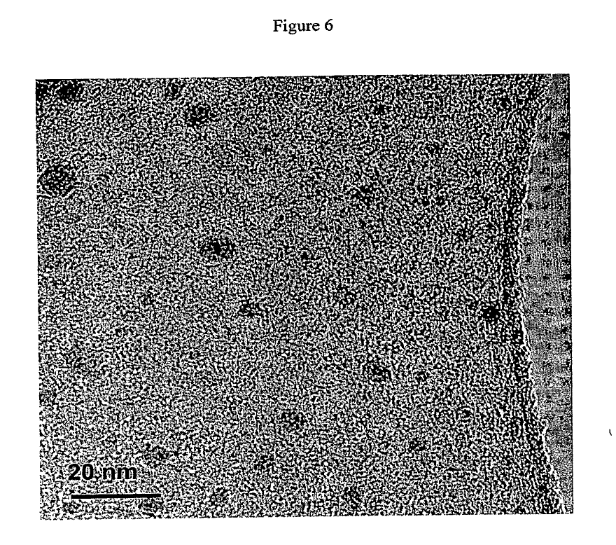

Transmission electron microscopy. TEM studies fully support results of Raman and XANES analyses, showing elimination of graphitic ribbons, carbon onions and graphitic shells in UD50 and a substantial decrease in amorphous carbon content in UD90 and UD98 after oxidation. FIG. 5 shows representative high resolution micrographs of UD50 and UD90 before and after annealing in air. The microstructure of UD98 was very similar to that of UD90 and thus is not presented separately. This is in agreement with XANES measurements showing similar sp²/sp³ carbon ratio for these grades before and after oxidation. Interestingly, the oxidation also decreased the degree of aggregation in ND samples. Prior to oxidation, no isolated diamond nanoparticles could be observed in TEM—they were always agglomerated. However, once oxidized, numerous single ND particles covered the lacey carbon on the TEM grid (FIG. 6). While agglomeration of nanoparticles depends on surface charge, chemistry, pH of the solution and other parameters, our observation indicates that oxidation removed the sp² carbon that bridged the diamond particles into clusters (Gruen, D. M.; Shenderova, O. A.; Vul, A. Y., Synthesis, Properties and Applications of Ultrananocrystalline Diamond. Springer: Dordrecht, 2005; Shenderova, O. A.; McGuire, G., Nanocrystalline Diamond. In Nanomaterials handbook, Gogotsi, Y., Ed. CRC Press: Boca Raton 2006; pp 203-237) in the as-produced or acid-purified ND. Once sp² carbon or other bridges in ND clusters are removed, dispersion of ND to single particles becomes feasible. This is a useful characteristic in many applications of ND.

The HyperChem models of ND particles (FIGS. 5e, f) summarize results of FTIR, XANES, Raman and TEM analyses. They show that a rather complex surface chemistry of initial diamond with graphite, hydrocarbons and oxygen-containing groups covering the surface becomes cleaner, more uniform and has a higher concentration of reactive oxygen-containing moieties attached.

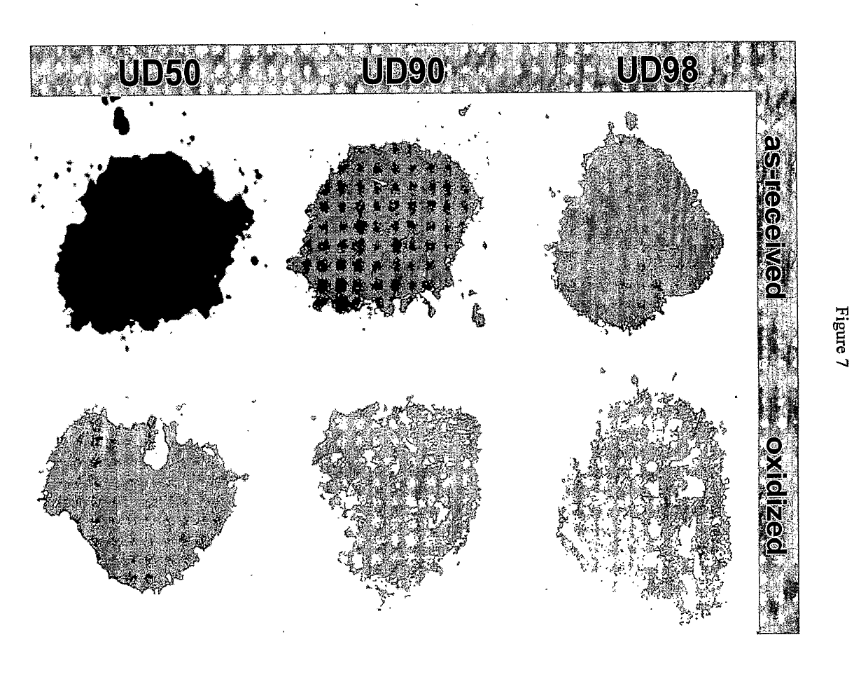

Optical imaging. Visual analysis of dry ND suggests substantial improvement in its technological properties after oxidation. The oxidized powder in the vials shows a liquid-like behavior when shaken, and flows easily, probably due to particle separation and breaking of agglomerates (FIG. 6). FIG. 7 shows optical images of the as-received and the oxidized ND. In general, the darkness of powders correlates quite well with the content of sp²-bonded carbon and other impurities in the samples (compare FIG. 7 with Tables 1, 2). Untreated UD50 appears velvet black. UD90 and UD98 look grey (UD90) or grey-brown (UD98). While all the purified samples appear light-grey in color, the oxidized UD98 looks very similar to microcrystalline diamond powder, confirming its high purity. Transparency of ND could be important for many potential applications in scratch resistant optics, windows, and displays. Removal of graphitic carbon is also expected to decrease the electrical conductivity of the powders. High electrical resistivity and high thermal conductivity of diamond may allow the use of ND in heat management as an additive to polymers. Due to the reduced level of impurities, the high diamond content and the uniform oxygen-bearing surface terminations, oxidized nanodiamond can be considered as the most appropriate starting material for further wet chemistry modification and biomedical applications. The simplicity and environmental friendliness of this single-step process should make it well accepted in both industrial and research environments.

These results demonstrate how amorphous and graphitic sp²-bonded carbon is selectively removed from nanodiamond powders by oxidation in air. A particularly useful temperature range for oxidation of the ND samples is 400-430° C. although other ranges can be used too, as described herein. Depending on the ND sample, for example, 5 h oxidation at 425° C. increased the content of sp³-bonded carbon from 23-81% in starting powders to 94-96%, as determined by XANES, and the weight loss was roughly equal to the content of sp² carbon in the sample. The purity of ND thus became comparable to that of microcrystalline diamond. Metal impurities, which were initially protected by carbon shells in the as-received samples, become accessible after oxidation and can be completely removed by further treatment in diluted acids. FTIR spectroscopy revealed that oxidation results in nanoparticles covered by oxygen-containing functional groups such as C═O, COOH, and OH. Carbonyl and carboxyl groups can be completely eliminated by subsequent hydrogenation at elevated temperatures.

These examples demonstrate the use of ambient air for the oxidative purification of diamond-bearing detonation soot, eliminating the need for any additional oxidizers, catalysts or inhibitors. Moreover, the presented techniques are also capable of significantly improving the quality of nanodiamond samples which underwent prior acid purification treatments without appreciable loss of the diamond phase. These results open avenues for numerous new applications of nanodiamond as described hereinabove.

What is claimed:

1. A process for increasing the sp-3 diamond carbon fraction of a nanodiamond composition, comprising:
providing a nanodiamond composition comprising sp-3 carbon and sp-2 carbon; and heating said nanodiamond composition in the presence of gaseous molecular oxygen to a temperature in the range of from about 375° C. to about 630° C.

2. The process of claim 1, wherein the nanodiamond composition is in the form of a powder.

3. The process of claim 2, wherein the powder comprises a plurality of nanodiamond particles characterized as having an average diameter in the range of from about 1 nm to about 30 nm.

4. The process of claim 3, wherein prior to heating, at least a portion of the nanodiamond particles comprise sp-3 carbon forming diamond phase cores encased by non-diamond phase sp-2 carbon.

5. The process of claim 4, wherein the non-diamond phase sp-2 carbon encasing the nanodiamond cores oxidizes away during heating to increase the sp-3 diamond carbon fraction of the nanodiamond composition.

6. The process of claim 3, wherein the powder comprises a plurality of nanodiamond particles characterized as having an average diameter in the range of from about 1 run to about 20 nm.

7. The process of claim 3, wherein the powder comprises a plurality of nanodiamond particles characterized as having an average diameter in the range of from about 2 nm to about 9 nm.

8. The process of claim 3, wherein the powder comprises a plurality of nanodiamond particles characterized as having an average diameter in the range of from about 3 nm to about 8 nm.

9. The process of claim 3, wherein the powder comprises a plurality of nanodiamond particles characterized as having an average diameter in the range of from about 4 nm to about 7 nm.

10. The process of claim 3, wherein the step of heating changes the average particle size of the nanodiamond particles.

11. The process of claim 10, wherein the step of heating reduces the average particle size of the nanodiamond particles.

12. The process of claim 10, wherein the step of heating increases the average particle size of the nanodiamond particles.

13. The process of claim 1, wherein the weight fraction of sp-3 carbon after heating is greater than the weight fraction of sp-3 carbon before heating.

14. The process of claim 1, wherein the temperature of the nanodiamond composition is maintained at a temperature between about 375° C. and about 450° C. for a time sufficient to increase the percent of sp-3 diamond carbon in the nanodiamond composition to greater than 50 percent.

15. The process of claim 14, wherein the time sufficient to increase the percent of nanodiamond in the nanodiamond composition to more than 50 percent is in the range of from about 1 second to about two days.

16. The process of claim 14, wherein the time sufficient to increase the percent of sp-3 diamond carbon in the nanodiamond composition to more than 50 percent is in the range of from about 10 seconds to about 10 hours.

17. The process of claim 14, wherein the time sufficient to increase the percent of sp-3 diamond carbon in the nanodiamond composition to more than 50 percent is in the range of from about 100 seconds to about 6 hours.

18. The process of claim 14, wherein the time sufficient to increase the percent of nanodiamond sp-3 carbon in the nanodiamond composition to more than 50 percent is in the range of from about 15 minutes to about 4 hours.

19. The process of claim 14, wherein the time sufficient to increase the percent of sp-3 diamond carbon in the nanodiamond composition to more than 50 percent is in the range of from about 30 minutes to about 3 hours.

20. The process of claim 1, wherein the temperature of the nanodiamond composition is maintained at a temperature between about 375° C. and about 600° C. for a time sufficient to increase the percent of sp-3 diamond carbon in the nanodiamond composition to more than 50 percent.

21. The process of claim 20, wherein the temperature of the nanodiamond composition is maintained at a temperature between about 375° C. and about 550° C. for a time sufficient to increase the percent of sp-3 diamond carbon in the nanodiamond composition to more than 50 percent.

22. The process of claim 21, wherein the temperature of the nanodiamond composition is maintained at a temperature between about 375° C. and about 500° C. for a time sufficient to increase the percent of sp-3 diamond carbon in the nanodiamond composition to more than 50 percent.

23. The process of claim 22, wherein the temperature of the nanodiamond composition is maintained at a temperature between about 375° C. and about 450° C. for a time sufficient to increase the percent of sp-3 diamond carbon in the nanodiamond composition to more than 50 percent.

24. The process of claim 23, wherein the temperature of the nanodiamond composition is maintained at a temperature between about 385° C. and about 440° C. for a time sufficient to increase the percent of sp-3 diamond carbon in the nanodiamond composition to more than 50 percent.

25. The process of claim 24, wherein the temperature of the nanodiarnond composition is maintained at a temperature between about 395° C. and about 435° C. for a time sufficient to increase the percent of sp-3 diamond carbon in the nanodiamond composition to more than 50 percent.

26. The process of claim 1, wherein the gaseous molecular oxygen is provided to the process using purified oxygen, an oxygen/inert gas mixture, ambient air, or any combination thereof.

27. The process of claim 26, wherein nitrogen is present in the reaction as the nanodiamond composition is heating.

28. The process of claim 1, wherein the step of heating the nanodiamond composition occurs at a pressure less than atmospheric pressure, greater than atmospheric pressure, or any combination thereof.

29. The process of claim 1, wherein during the heating step the nanodiamond composition is heated in the presence of a non-reactive gas.

30. The process of claim 29, wherein the non-reactive gas comprises nitrogen, helium, neon, argon, krypton, xenon, or any combination thereof.

31. The process of claim 1, wherein the nanodiarnond composition is produced by detonation synthesis.

32. The process of claim 1, wherein the sp-2 carbon is present in the form of one or more non-diamond carbon phases in the nanodiamond composition.

33. The process of claim 32, wherein the non-diamond carbon comprises carbon onion, carbon fullerene shell, amorphous carbon, graphitic carbon, or any combination thereof.

34. The process of claim 32, wherein at least a portion of the non-diamond carbon is oxidized.

35. The process of claim 34, wherein at least about 50 percent by weight of the non-diamond carbon is oxidized.

36. The process of claim 35, wherein at least about 90 percent by weight of the non-diamond phase is oxidized.

37. The process of claim 36, wherein substantially all of the non-diamond phase is oxidized.

38. The process of claim 1, further comprising the step of monitoring the composition while heating the nanodiamond composition.

39. The process of claim 38, wherein the weight, the chemical composition, or both, of the nanodiamond composition are monitored while heating the nanodiamond composition.

40. The process of claim 1, wherein the nanodiamond composition comprises less than about 85 percent sp-3 diamond carbon based on total weight of the nanodiamond composition prior to heating, and greater than about 90 percent sp-3 diamond carbon based on total weight of the nanodiamond composition after heating.

41. The process of claim 1, where the nanodiamond composition further comprises one or more non-carbon impurities, and the temperature of the nanodiamond composition is maintained at a temperature between about 375° C. and about 450° C. for a time sufficient to increase the percent of sp-3 diamond carbon in the nanodiamond composition to more than 50 percent.

42. The process of claim 41, wherein the non-carbon impurities comprise iron-containing particles.

43. The process of claim 42, wherein the iron content of the nanodiamond composition is in the range of from about 0.005 atomic percent to about 5 atomic percent, based on total percent of the nanodiamond composition.

44. The process of claim 1, where the nanodiamond composition is substantially free of non-carbon impurities prior to heating, and the temperature of the nanodiamond composition is maintained at a temperature between about 450° C. and about 630° C. for a time sufficient to increase the percent of sp-3 diamond carbon in the nanodiamond composition to more than 50 percent.

45. The process of claim 1, wherein the sp-3 carbon content and the sp-2 carbon content are determined using XANES.

46. The process of claim 45, wherein after heating the sp-2 carbon content is less than about 6 percent.

47. The process of claim 45, wherein after heating the ratio of sp-3 carbon to sp-2 carbon is at least about 15.

48. The process of claim 45, wherein the ratio of sp-3 carbon to sp-2 carbon after heating is at least about 5 times greater then the ratio of sp-3 carbon to sp-2 carbon before heating.

49. The process of claim 45, wherein the ratio of sp-3 carbon to sp-2 carbon after heating is at least about 10 times greater then the ratio of sp-3 carbon to sp-2 carbon before heating.

50. The process of claim 1, further comprising the step of contacting the nanodiamond composition, after the heating step, with an acidic solution to remove one or more metal impurities in the nanodiamond composition.

51. A process for increasing the sp-3 diamond carbon fraction of a nanodiamond composition, consisting essentially of;
heating a nanodiamond composition comprising sp-3 diamond carbon and sp-2 carbon in the presence of gaseous molecular oxygen to a temperature in the range of from about 375° C. to about 630° C.

52. The process of claim 5 1, wherein the weight fraction of sp-3 diamond carbon after heating is greater than the weight fraction of sp-3 diamond carbon before heating.

53. The process of claim 5 1, wherein the nanodiamond composition comprises less than about 35 percent sp-3 diamond carbon based on total weight of the nanodiamond composition prior to heating, and greater than about 50 percent sp-3 diamond carbon phase based on total weight of the nanodiamond composition after heating.

54. A nanodiamond composition comprising a plurality of nanodiamond particles comprising greater than about 95 percent of sp-3 diamond carbon based on total sp-3 carbon and sp-2 carbon, said plurality of nanodiamond particles having an average particle size in the range of from about 1 nm to about 30 nm.

55. The nanodiamond composition of claim 54 wherein the sp-3 carbon and sp-2 carbon contents are determined using XANES.

56. The nanodiamond composition of claim 55, wherein the sp-2 carbon content is less than about 4 percent.

57. The nanodiamond composition of claim 55, wherein the ratio of sp-3 carbon to sp-2 carbon is at least about 20.

58. The nanodiamond composition of claim 54, wherein said nanodiamond particles further comprise one or more reactive oxygen bearing functional groups externally disposed on their surface.

59. A coating comprising the composition of claim 54.

60. An abrasive comprising the composition of claim 54.

61. An oil additive comprising the composition of claim 54.

62. A rheology modifier comprising the composition of claim 54.

63. A composite material comprising the composition of claim 54.

64. A cleaning agent comprising the composition of claim 54.

65. A chromatographic media comprising the composition of claim 54.

66. A method of decreasing the degree of aggregation in a nanodiamond composition, comprising:
providing a nanodiamond aggregate composition comprising a plurality of nanodiamond aggregates having an average diameter in the range of from about 10 nm to about 100,000 nm, the aggregates comprising a plurality of nanodiamond particles having an average diameter in the range of from about 1 nm to about 30 nm; and
heating said nanodiamond aggregate composition in the presence of gaseous molecular oxygen to a temperature in the range of from about 375° C. to about 630° C. to give rise to a reduction in the average diameter of the aggregates.

67. A nanodiamond powder made according to the process in claim 66.

68. An abrasive comprising the nanodiamond powder of claim 67.

69. An oil additive comprising the nanodiamond powder of claim 67.

70. A rheology modifier comprising the nanodiamond powder of claim 67.

71. A composite material comprising the nanodiamond powder of claim 67.

72. A cleaning agent comprising the nanodiamond powder of claim 67.

73. A coating comprising the nanodiamond powder of claim 67.

74. A chromatographic media comprising the nanodiamond powder of claim 67.

75. A method of increasing the degree of aggregation in a nanodiamond composition, comprising:
heating a nanodiamond composition in the presence of gaseous molecular oxygen to a temperature in the range of from about 375° C. to about 630° C. to give rise to production of oxygen-containing bridge structures of the type nanodiamond-C(═O)—O-nanodiamond, nanodiamond-O-nanodiamond, nanodiamond-C(═O)-nanodiamond, or any combination thereof, wherein the bridge structures give rise to nanodiamond aggregates having an average diameter in the range of from about 10 nm to about 100,000 nm, the aggregates comprising a plurality of nanodiamond particles having an average diameter in the range of from about 1 nm to about 30 nm.

76. A nanodiamond aggregate made according to the process of claim 75.

77. A coating comprising the nanodiamond aggregate of claim 76.

78. An abrasive comprising the nanodiamond aggregate of claim 76.

79. An oil additive comprising the nanodiamond aggregate of claim 76.

80. A rheology modifier comprising the nanodiamond aggregate of claim 76.

81. A composite material comprising the nanodiamond aggregate of claim 76.

82. A cleaning agent comprising the nanodiamond aggregate of claim 76.

83. A chromatographic media comprising the nanodiamond aggregate of claim 54.

84. A process for increasing the sp-3 diamond carbon fraction of a nanodiamond composition, comprising:
providing a nanodiamond composition comprising sp-3 carbon and sp-2 carbon; and
heating said nanodiamond composition in the presence of a gaseous oxidizing agent other than molecular oxygen or ozone, or a plasma oxidizing agent, or both, to a temperature in the range of from about 25° C. to about 900° C.

85. The process of claim 84, wherein the gaseous oxidizing agent comprises elemental oxygen covalently bonded to one or more atoms other than oxygen.

86. The process of claim 84, wherein the gaseous oxidizing agent comprises carbon dioxide, potassium hydroxide, water, or both.

87. The process of claim 84, wherein the temperature is at least about 375° C.

88. The process of claim 84, wherein during the heating step the nanodiamond composition is heated in the presence of the gaseous oxidizing agent and a non-reactive gas.

89. The process of claim 88, wherein the non-reactive gas comprises nitrogen, helium, neon, argon, krypton, xenon, or any combination thereof.

90. The process of claim 84, wherein the plasma comprises a hydrogen plasma, an argon plasma, an oxygen plasma, a helium plasma, or any combination thereof.
